(19) United States
(12) Patent Application Publication
(10) Pub. No.: US 2026/0218546 A1
(43) Pub. Date: Jul. 30, 2026

(54) MOTOR VEHICLE LOCK

(71) Applicant: Kiekert Aktiengesellschaft, Heiligenhaus (DE)

(72) Inventor: Martin KREJCÍ, Zlunice (CZ)

(73) Assignee: Kiekert Aktiengesellschaft, Heiligenhaus (DE)

(21) Appl. No.: 19/146,248

(22) PCT Filed: Nov. 14, 2023
(86) PCT No.: PCT/DE2023/100874

§ 371 Date: Jul. 8, 2025

(30) Foreign Application Priority Data
Jan. 17, 2023 (DE) 10 2023 100 960.5

(51) Int. Cl. E05B 79/08; E05B 83/18

(52) U.S. Cl. CPC E05B 79/08; E05B 83/18

(57) ABSTRACT

A motor vehicle lock, in particular a motor vehicle tailgate lock, which is equipped with a locking mechanism substantially consisting of a rotary latch and a pawl. Furthermore, an additional reinforcing element couples the rotary pin of the rotary latch to the rotary pin of the pawl at a distance to a lock case. According to the invention, the reinforcing element is additionally connected to a door panel or a vehicle body component.

The invention relates to a motor vehicle lock, in particular a motor vehicle tailgate lock, with a locking mechanism consisting essentially of a rotary latch and a pawl, and with an additional reinforcing element which couples at least the rotary pin of the rotary latch to the rotary pin of the pawl at a distance from a lock case.

In the category-defining prior art according to DE 20 2012 007 326 U1, the reinforcing element ensures, in particular, that crash safety is improved and that malfunctions are reliably avoided, while maintaining a simple design. Such crash situations usually correspond to the locking mechanism performing or being able to perform an unintentional opening movement. As a result, there is a possibility that a motor vehicle door that was previously held by the lock holder may accidentally open and no longer protect the occupants of the motor vehicle.

In fact, the unintentional opening of the motor vehicle door means that safety devices such as side airbags, side impact protection, etc., can no longer be effective. In addition, when the motor vehicle door is open, the motor vehicle door in question can no longer contribute to stiffening the vehicle body. Accordingly, it must be ensured, particularly in the event of a crash, that the locking mechanism consisting of the rotary latch and pawl continues to hold the lock holder or a striker provided at this point correctly.

The previously referenced and category-defining prior art according to DE 20 2012 007 326 U1 has proven itself. The reinforcing element is typically a reinforcing plate arranged to be coplanar to the bearing plane of the locking mechanism. In this way, the reinforcing plate and the bearing plane for the locking mechanism, in conjunction with the bearing bolts defining the respective rotary pin, define a supporting structure with a rectangular cross-section. With the help of this supporting structure, forces acting upon the motor vehicle lock according to the invention, and in particular the lock case, are absorbed particularly effectively in the event of a crash and are transmitted to the associated motor vehicle door or the motor vehicle body.

In fact, a lock holder or striker that interacts with the motor vehicle lock is usually provided on the vehicle body side, whereas the motor vehicle lock is present and attached in or on the associated motor vehicle door. In this case, the term “motor vehicle door” is to be interpreted broadly, so that it does not include only, for example, motor vehicle side doors or motor vehicle tailgates. Rather, the term motor vehicle door generally also includes, in the context of the invention, motor vehicle hoods, but also motor vehicle fuel caps, motor vehicle charging covers, or any other motor vehicle flaps in or on an associated motor vehicle.

The known procedures have proven successful, but still offer room for improvement. The reinforcing element, typically designed as a reinforcing plate, thus ultimately provides stiffening for the lock case and the bearing bolts that define the rotary pins. The supporting structure already mentioned is defined thereby. This is to say that any forces absorbed by the reinforcing element are ultimately transferred into the motor vehicle door via the bearing bolts and the lock case if the lock case is screwed to the motor vehicle door. The same applies, of course, if the lock case is attached to a motor vehicle body, which is also possible. In this case, the corresponding motor vehicle door has the lock holder that interacts with the motor vehicle lock.

As a result, forces acting upon the reinforcing element are indirectly transmitted to the motor vehicle door or the motor vehicle body, viz., via the bearing bolts or the lock case. This can result in a reduced effectiveness of the power transmission if, for example, one or both bearing bolts are deformed in this process, in conjunction with any additional fastening bolts that may also be provided. As a result, losses in strength, particularly in the event of a crash, or losses in terms of effective power transmission, can be observed. The invention as a whole seeks to remedy this.

The invention is based upon the technical problem of developing such a motor vehicle lock and in particular a motor vehicle tailgate lock such that the force introduction into the motor vehicle door or motor vehicle body is improved, in particular in the event of a crash.

To solve this technical problem, the invention proposes, in a motor vehicle lock of the type in question, that the reinforcing element not only couple the two rotary pins of the rotary latch, on the one hand, and the pawl, on the other, at a minimum distance from the lock case, but additionally be connected to a door wing or a vehicle body component.

According to the invention, the reinforcing element does not only ensure that the lock case or the rotary pins of the locking mechanism, which are typically defined by means of bearing bolts, are stiffened. The reinforcing element also provides a connection to the door wing or a vehicle body component. The first case corresponds to the fact that the motor vehicle lock according to the invention is fastened in or on a motor vehicle door. In this case, the reinforcing element does not only stiffen the bearing bolts that define the rotary pins of the locking mechanism and thus the lock case. Rather, the reinforcing element also ensures that the door wing is ultimately coupled to the lock case, and specifically in addition to the already provided fixing of the lock case to the door wing in question. In this way, any forces acting upon the locking mechanism, particularly those observed in the event of a crash, are transmitted not only into the door wing via the lock case with stiffening by the reinforcing element, but also directly into the door wing in question via the reinforcing element. This provides additional stiffening of the door wing in the region where the lock case is attached, and thus also of the motor vehicle lock itself, so that functional impairments of the locking mechanism inside the motor vehicle lock are avoided even in the event of a crash.

Similarly, this applies for the case where, in addition to its stiffening function, the reinforcing element is alternatively supported on a vehicle body component or is connected to such a vehicle body component with regard to the lock case and the bearing bolts. The vehicle body component may be a motor vehicle body frame that accommodates the associated motor vehicle door. In this case, too, the reinforcing element continues to stiffen the lock case and the bearing bolts of the locking mechanism mounted in the lock case on the one hand, and also ensures that forces acting upon the locking mechanism are additionally transmitted directly into the body via the reinforcement element. In both cases, there is a particularly effective transmission of force in the event of a crash from the locking mechanism via the lock case into the door wing or vehicle body component on the one hand, and additionally, and on the other hand, a further transmission of force via the relevant reinforcing element directly into the door wing or vehicle body component in question. This provides a particularly functionally reliable structure even in the event of a crash, because it additionally stiffens the door wing or vehicle body component. These are the main advantages.

In order to achieve this in detail, the reinforcing element is equipped with a locking plate, arranged predominantly parallel to the lock case, and a wing hood connected to the door wing or the vehicle body component. This is to say that the reinforcing element essentially consists of two different functional elements, viz., the locking plate on the one hand and the wing hood on the other. While the locking plate typically provides for the stiffening of the lock case by creating a rectangular supporting structure between the locking plate in question, the bearing bolts, and the lock case, which runs predominantly parallel to them, comparable to the previously described prior art according to DE 20 2012 007 326 U1, the wing hood has the additional function of supporting or coupling the reinforcing element directly with the door wing or the vehicle body component.

For this purpose, the wing hood is usually convex in the closing direction of the corresponding motor vehicle door. Since the motor vehicle door is equipped with a door wing, the closing direction of the door wing corresponds to the closing direction of the vehicle door. If a crash occurs in such a case, the motor vehicle door in question is usually subjected to additional pressure in this closing direction, especially if it is a tailgate. As a result, forces associated with the crash situation, which predominantly run in the closing direction, can be absorbed particularly effectively by the wing hood, which is convexly curved in this direction and directly connected to the door wing.

For this purpose, the wing hood is generally equipped with three wing arms, which run predominantly at right angles to each other. In this context, it has proved particularly favorable if the central wing arm is designed having a longitudinal slot. In addition, the central wing arm in question or the longitudinal slot created at this point typically has lateral reinforcing ribs. In addition, the design is usually such that the central wing arm with the longitudinal slot is additionally curved upwards like a rib compared to the two side wing arms. In this case, the previously mentioned reinforcing ribs are typically connected to the longitudinal slot, and specifically in each case at the edges in its longitudinal direction.

In this way, a particularly effective force introduction is provided. This is because the wing hood is convexly curved in the closing direction. If any crash forces act upon the motor vehicle lock according to the invention in this closing direction, these are primarily absorbed by the wing hood in question and here in particular the central wing arm with the longitudinal slot. As a result, the longitudinal slot may open due to deformation. At the same time, however, the two reinforcing ribs, which are connected to the longitudinal slot at each edge in the longitudinal direction, ensure that the opening of the longitudinal slot is predominantly symmetrical to an imaginary line of symmetry and, moreover, that the reinforcing ribs prevent any deformation of the central wing arm, as well as any possible shearing.

Rather, there is a more or less uniform transmission of force from the door wing or the tailgate in the example case to the wing hood, and, here, primarily the central wing arm with the longitudinal slot, which is deformed as a result. Nevertheless, the central wing arm in conjunction with the two side wing arms ensures that the force associated with the crash is further absorbed by the locking plate connected to the wing hood or integral with it and is passed on via the bearing bolts, the lock case, and finally into the lock holder caught by the locking mechanism, and thus to the vehicle body.

In any case, the door wing is designed to be particularly rigid at this point, thus preventing any deformation of the locking mechanism from being observed in the event of a crash, which could allow the door wing or the associated motor vehicle door or motor vehicle tailgate to be opened unintentionally.

In this connection, it has also proven useful if the longitudinal slot ends in each case in a cross-section at the end. This allows particularly effective deformations and, in particular, upward curvatures of the central wing arm with the central longitudinal slot and the lateral reinforcing ribs. Further reinforcement measures are provided in such a way that additional reinforcing ribs are implemented in addition to the reinforcing ribs running along the edges in the longitudinal direction of the longitudinal slot. In this case, these additional reinforcing ribs can be provided on the edge of the reinforcing hood in the region of the two side wing arms. These additional reinforcing ribs are usually found at least in the corresponding fastening regions, with the help of which the two side wing arms are fixed to the door wing.

The invention also relates to a motor vehicle lock arrangement with a door wing and a motor vehicle lock of the construction described above. In this connection, a vehicle body-side lock holder is also provided. In this connection, the motor vehicle lock arrangement according to the invention has a front-side cover of the motor vehicle lock and a hood-side receptacle for the lock holder. In addition, the design is such that the cover and the hood, as part of the hood-side receptacle, interlock when closed. For this purpose, the cover and the hood in question can each be designed as plastic injection-molded parts.

The invention is explained in greater detail below with reference to drawings which show only one exemplary embodiment. In the drawings:

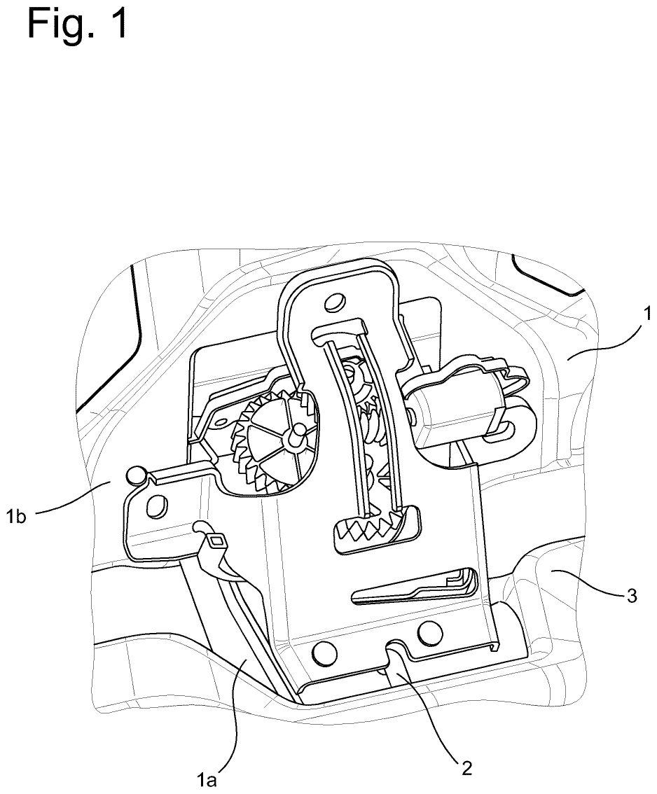

FIG. 1 shows a perspectival overview of the motor vehicle lock according to the invention, and

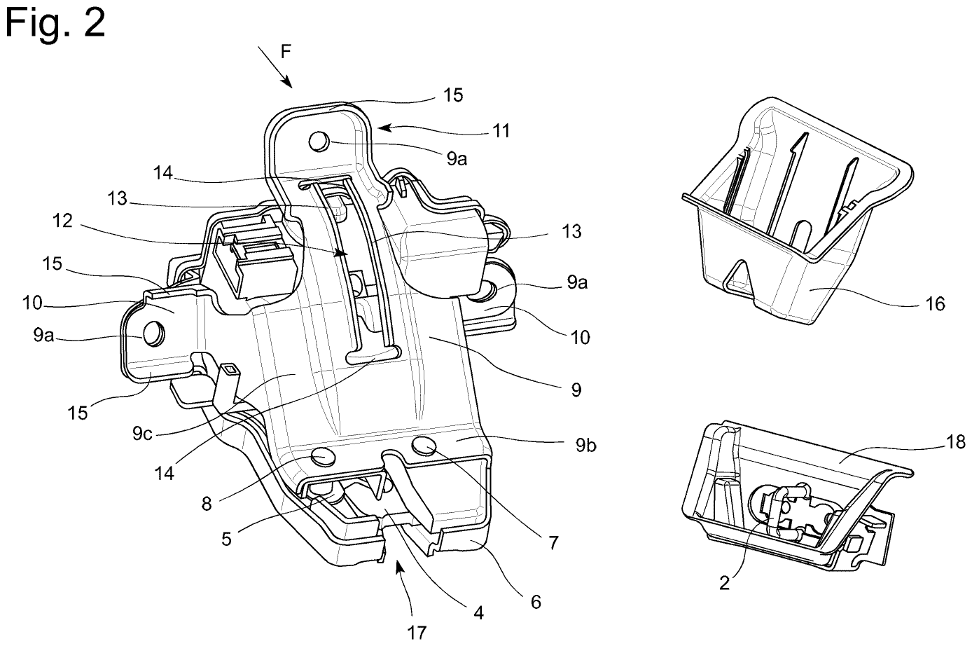

FIG. 2 shows the motor vehicle lock arrangement according to the invention with its individual parts.

The figures show a motor vehicle lock which, according to the exemplary embodiment, is designed as a motor vehicle tailgate lock. In fact, the motor vehicle tailgate lock in question is located inside a motor vehicle tailgate with door wing 1. The motor vehicle lock in question interacts with a vehicle body-side lock holder 2, which is only partially visible in FIG. 1 and which is fully reproduced in FIG. 2. In principle, the motor vehicle lock, which will be described in detail below, can also be fixed to a motor vehicle body or vehicle body 3, whereas the lock holder 2 is located on the door wing 1. However, this is not shown.

As usual, the motor vehicle lock has a locking mechanism 4, 5 consisting substantially of a rotary latch 4 and a pawl 5. This can be seen best from the illustration according to FIG. 2. For this purpose, the locking components 4, 5 in question, i.e., the rotary latch 4 and the pawl 5, are rotatably accommodated in a metal lock case 6. Bearing bolts 7 and 8 in each case ensure the rotatable bearing. In this case, the bearing bolt 7, which rotatably supports the rotary latch 4, defines the rotary pin of the rotary latch 4. In contrast, the bearing bolt 8 ensures that the pawl 5 is rotatably mounted in the lock case 6 and an associated rotary pin is observed.

Both bearing bolts 7, 8 are fixed on the one hand in the metal lock case 6 and on the other in an additional reinforcing element 9. For this purpose, both bearing bolts 7, 8 can be riveted in the respective lock case 6 or the reinforcing element 9, or otherwise connected to the metal structural component 6, 9 in question. In this connection, the reinforcing element 9 ensures that the rotary pin of the rotary latch 4 on the one hand and the rotary pin of the pawl 5 on the other are coupled to each other at a distance from the lock case 6. For this purpose, the reinforcing element 9 defines, at least in portions, a rectangular supporting structure which is composed of the metal reinforcing element 9, the lock case 6 which is at least partially parallel to it and is also metal, and the two bearing bolts 7, 8 connected thereto.

According to the invention, the reinforcing element 9 is additionally connected to the door wing 1 or a vehicle body component. This is to say that the reinforcing element 9 ensures, on the one hand, that the two bearing bolts 7, 8 of the rotary latch 4 and the pawl 5 are coupled to the lock case 6. On the other hand, the reinforcing element 9 additionally ensures a direct coupling to the door wing 1. If the illustrated motor vehicle lock is mounted in or on the vehicle body 3, the reinforcing element 9 alternatively couples the two bearing bolts 7, 8 and the lock case 6 to the respective vehicle body 3.

According to the exemplary embodiment, however, the reinforcing element 9 ensures an additional force-locking connection not only of the lock case 6 to the bearing bolts 7, 8, but also such that the lock case 6 is additionally connected to the door wing 1 via the reinforcing element 9. In this case, the invention is based upon the finding that the lock case 6 is, on the one hand, directly connected to the door wing 1 in question, e.g., screwed, and is, additionally, indirectly connected to the door wing 1 at another point via the reinforcing element 9. This can again be done via a screw connection at corresponding fastening regions 9a of the reinforcing element 9.

In this case, the invention is based upon the further finding that the door wing 1 of the motor vehicle tailgate realized at this point is, in the region where the motor vehicle lock in question is attached, largely rectangular or approximately rectangular in shape in the edge region. In this case, the metal lock case 6 is predominantly connected to a horizontally or largely horizontally extending leg 1a of the door wing 1, whereas the fastening regions 9a of the reinforcing element 9 form a connection with a further leg 1b, which, in contrast, runs vertically or largely vertically, of the door wing 1.

In this way, the reinforcing element 9 ensures not only that the two bearing bolts 7, 8 of the locking components 4, 5 are additionally stiffened with the lock case 6. Rather, the reinforcing element 9 provides additional stiffening of the door wing 1 in the edge region or in the fastening region of the motor vehicle lock, because the reinforcing element 9 additionally couples, on the one hand, the largely horizontally extending leg 1a of the door wing 1 and, on the other, the vertically or largely vertically extending leg of the door wing 1. This is to say that the reinforcing element 9 runs like a kind of diagonal cross member between the two legs 1a, 1b. This additionally stiffens the door wing 1 in this region.

For this purpose, the reinforcing element 9 firstly has a locking plate 9b arranged and running predominantly parallel to the lock case 6. The locking plate 9b, in conjunction with the bearing bolts 7, 8 fixed to the locking plate 9b of the rotary latch 4 on the one hand and the pawl 5 on the other, in conjunction with the lock case 6, ensures the rectangular supporting structure realized at this point, which ensures the stiffening of the lock case 6 and the locking mechanism 4, 5 comparable to the prior art according to DE 20 2012 007 326 U1. In addition, the reinforcing element 9 is equipped with a wing hood 9c connected to the door wing 1 according to the exemplary embodiment. This wing hood 9c ultimately provides the previously described stiffening of the corner region between the two legs 1a, 1b of the door wing 1.

For this purpose, the wing hood 9c is equipped with three wing arms 10, 11, which run predominantly at right angles to each other. In this case, two side wing arms 10 and a central wing arm 11 are realized. The central wing arm 11 is longitudinally slotted and has a longitudinal slot 12 for this purpose. The longitudinal slot 12 in turn has lateral reinforcing ribs 13. In fact, two reinforcing ribs 13 are provided, each of which is connected to the longitudinal slot 12 at the edge and which in each case delimit the longitudinal slot 12 at the edge in the longitudinal extension, or run in the longitudinal direction along the edges of the longitudinal slot 12. It can also be seen that the central wing arm 11 is curved upwards like a rib compared to the two side wing arms 10.

The longitudinal slot 12 in turn merges in each case into transverse slots 14 at the end. As a result, particularly in the event of a crash, the longitudinal slot 12 widens predominantly symmetrically compared to a central plane of symmetry. In this case, the widening is controlled and not torsional, which is ensured by the lateral reinforcing ribs 13. At the same time, this deformation of the central wing arm 11 in the region of the longitudinal slot 12 is permitted by the respective transverse slots 14 at the end of the longitudinal slot 12. This can essentially be attributed to the fact that forces associated with such a crash regularly run in the closing direction of door wing 1. For this purpose, corresponding forces are indicated in FIG. 2 by an arrow F.

In any case, such a crash and the associated forces F in the direction indicated in FIG. 2 lead to the central wing arm 11 being widened and possibly also curving upwards relative to the two side wing arms 10. This may happen along the already existing upward curvature of the central wing arm 11 compared to the two side wing arms 10. Due to the provided longitudinal slot 11 in conjunction with the reinforcing ribs 13, this process does not lead to the reinforcing element 9 twisting or tearing off as a whole. This ensures that the wing hood 9c is and remains integrally connected to the locking plate 9b. As a result, the locking plate 9b can still ensure that the bearing bolts 7, 8 of the rotary latch 4 on the one hand and the pawl 5 on the other remain in place and experience the desired stiffening relative to the locking plate 6. Any unintentional opening of the locking mechanism 4, 5 can thus be ruled out.

This is further enhanced by the fact that further and additional reinforcing ribs 15 are provided on the edge of the reinforcing hood 9, at least in the fastening regions 9a. These additional reinforcing ribs 15 ensure that the fastening regions 9a of the wing hood 9 do not deform or do not deform significantly even in the event of a crash and, in particular, that the wing hood 9 cannot tear off. These are the main advantages.

The illustration according to FIG. 2 also shows a motor vehicle lock arrangement which, in addition to the door wing 1 and the motor vehicle lock already described, also shows the vehicle body-side lock holder 2 separately therefrom. The motor vehicle lock arrangement has a front-side cover 16 of the motor vehicle lock, which is pushed on from the front via an inlet mouth 17 with the two locking components 4, 5. The front-side cover 16 in question corresponds to a hood 18 which surrounds the lock holder 2 attached to the vehicle body 3. In the assembled state and closed position of the motor vehicle tailgate or door wing 1, the cover 16 engages in the hood 18—specifically, largely or at least predominantly in a form-fitting manner. This additionally centers the motor vehicle lock relative to the motor vehicle body 3 and guides the motor vehicle tailgate during the closing process.

### LIST OF REFERENCE SIGNS

door wing 1
leg 1a
leg 1b
lock holder 2
motor vehicle body 3
rotary latch 4
locking mechanism 4, 5
locking mechanism components 4, 5
pawl 5
lock case 6
structural component 6, 7
bearing bolt 7, 8
structural pin 7, 8
bearing bolt 8
reinforcing element 9
wing hood 9
fastening regions 9a
locking plate 9b
wing hood 9c
wing arms 10, 11
longitudinal slot 12
reinforcing ribs 13
transverse slots 14
reinforcing ribs 15
cover 16
inlet mouth 17
hood 18
arrow F
forces F

1. A motor vehicle lock, in particular a motor vehicle tailgate lock, having a locking mechanism substantially consisting of a rotary latch and a pawl, and having an additional reinforcing element that couples at least the rotary pin of the rotary latch to the rotary pin of the pawl at a distance from a lock case,
wherein
the reinforcing element is additionally connected to a door panel or a vehicle body component.

2. The motor vehicle lock according to claim 1, wherein the reinforcing element is equipped with a locking plate, arranged predominantly parallel to the lock case, and a wing hood connected to the door wing or the vehicle body component.

3. The motor vehicle lock according to claim 2, wherein the wing hood is convexly curved in the wing closure direction.

4. The motor-vehicle lock according to claim 2, wherein the wing hood has three wing arms each running predominantly at right angles to one another.

5. The motor vehicle lock according to claim 4, wherein a central wing arm is longitudinally slotted with lateral reinforcing ribs.

6. The motor vehicle lock according to claim 4, wherein the central wing arm is curved upwards in a rib-like manner relative to the two lateral wing arms.

7. The motor vehicle lock according to claim 5, wherein the two reinforcing ribs are each connected to a longitudinal slot at the edge in the longitudinal direction.

8. The motor vehicle lock according to claim 7, wherein the longitudinal slot-leads in each case into a transverse slot at the end.

9. The motor vehicle lock according to claim 1, wherein additional reinforcing ribs are provided on the edge of the reinforcing hood at least in associated fastening regions.

10. A motor vehicle lock arrangement comprising: a door wing, a motor vehicle lock according to claim 1, a vehicle body-side lock holder, a front-side cover of the motor vehicle lock, and a hood-side receptacle for the lock holder, wherein the cover and a hood for the lock holder engage with one another in a closed state.
